(19) United States
(12) Patent Application Publication
(10) Pub. No.: US 2005/0128995 A1
(43) Pub. Date: Jun. 16, 2005

(54) Method and apparatus for using wireless hotspots and semantic routing to provide broadband mobile serveices

(76) Inventors: Maximilian A. Ott, Pennington, NJ (US); Ivan Seskar, Franklin Park, NJ (US); Manpreet Singh, Woodbridge, NJ (US)

Correspondence Address: WILMER CUTLER PICKERING HALE AND DORR LLP, 399 PARK AVENUE, NEW YORK, NY, 10022, US

(21) Appl. No.: 10/954,031

(22) Filed: Sep. 27, 2004

Related U.S. Application Data
(60) Provisional application No. 60/506,819, filed on Sep. 29, 2003.
(60) Provisional application No. 60/551,458, filed on Mar. 9, 2004.

(51) Int. Cl. H04B 7/216; H04J 3/24; H04L 12/66

(52) U.S. Cl. 370/349; 370/352

(57) ABSTRACT

A system and method for providing cost-effective broadband mobile services using a hybrid wireless network consisting of wide-area cellular (“3G”) supplemented by hotspot caches are provided. The proposed architecture uses opportunistic access of high-bandwidth wireless hotspot to dramatically reduce the cost per MB of media delivered to mobile end-users. The system also uses a “semantic multicast routing” approach to caching and delivering media based on individual user profiles.

### CROSS REFERENCE TO RELATED APPLICATIONS

This application claims the benefit under 35 U.S.C. § 119(e) of U.S. Provisional Patent Application Nos. 60/506,819, filed Sep. 29, 2003 and 60/552,458, filed Mar. 12, 2004, which are both hereby incorporated by reference herein in their entireties.

This application is related to the following pending U.S. patent applications, which are assigned to the assignee of this application:
High-performance Addressing and Routing of Data Packets with Semantically Descriptive Labels in a Computer Network (U.S. patent application Ser. No. 09/922,127), filed on Aug. 3, 2001; and
Dynamic Content Based Multicast Routing in Mobile Networks (U.S. patent application Ser. No. 10/271,502), filed on Oct. 15, 2002.

### FIELD OF THE INVENTION

This present invention relates to a system and a method for providing efficient information services to users of wireless devices. More particularly, the present invention relates to a system and method for providing “near real-time” mobile multimedia services using a wireless local area network (LAN) hotspot together with data caching and opportunistic delivery of content based on user preferences. The proposed system and method supports cost-effective mobile applications that are available to the user at any time and any place, but only need broadband connectivity inside hotspots.

### BACKGROUND

Most media-centric services do not require real-time connectivity to a remote repository. The best example is an MP3 player. Users are required to connect the player to a computer, download all the required songs, and then disconnect. From then on, they can listen to their music wherever they carry their player (assuming a charged battery). The real-time component is restricted to playback from local storage. In fact, many newer mobile telephones have an integrated MP3 player with sizable local storage. However, these phones still require a user initiated download to the mobile telephone from a computer. The deliberate “content charging” together with the linkage to an additional computer clearly restricts the user base as well as by-passes the mobile service provider. An integrated solution would download content from content repositories over the wireless operator's data network. Unfortunately, the cost for that would be prohibitive and the capacity of cellular data networks may restrict the number of simultaneously supported users.

The revenue potential of broadband mobile data services is the most sensitive assumption in the business case for deploying 3G networks. The objective of providing media-rich applications at attractive prices for the “always-connected” lifestyle of mobile users continues to come against the high costs of licensing, deploying, and maintaining 3G wireless infrastructures. In contrast, wireless LAN technology offers a much more attractive cost/performance but supports only localized coverage (sometimes referred to herein as a “hotspot”). An application or service that is only available in certain areas will have limited appeal to the wider user community. As a result, service providers are considering how wireless LAN hotspots could complement 3G/cellular services to offer viable mass-market services with global coverage.

Accordingly, it is desirable to provide systems and methods that overcome these and other deficiencies of the prior art.

### SUMMARY OF THE INVENTION

In accordance with one embodiment of the present invention, systems and methods for routing content through a network having at least one wireless base station from at least one content provider to at least one wireless device are provided. Content from a content provider is received at a wireless base station, where the content has at least one content descriptor. The wireless base station includes an information profile and stores the content that matches the information profile in a storage device. In response to receiving an interest profile and a cache directory associated with a wireless device, data packets for transmission to the wireless device are generated based at least in part on the received interest profile and the received cache directory. The data packets are then transmitted from the wireless base station to the wireless device.

According to another embodiment of the present invention, the wireless base station subscribes to content from a content provider or a content network based on the information profile associated with the wireless base station.

According to yet another embodiment of the present invention, the wireless base station downloads content from content providers or a content network based on the information profile associated with the wireless base station.

According to yet another embodiment of the present invention, the wireless base station updates the information profile associated with the wireless base station based on the received interest profile.

According to yet another embodiment of the present invention, the wireless base station updates the information profile associated with the wireless base station based on information profiles associated with other wireless base stations and interest profiles received at other wireless base stations.

In accordance with one embodiment of the present invention, methods for routing content through a network having at least one wireless base station from at least one content provider to at least one wireless device are provided. The wireless base station connects to a hybrid network, which comprises at least one hotspot data network and at least one cellular network. Content from at least one content provider is received at a wireless base station through the hybrid network, where the content has at least one content descriptor. The wireless base station includes an information profile and stores the content that matches the information profile at the wireless base station. In response to receiving an interest profile and a cache directory associated with a wireless device, data packets for transmission to the wireless device are generated based at least in part on the received interest profile and the received cache directory. In response to receiving an indication from the user of the wireless device to transmit the stored content to the wireless device when the wireless device is in an area covered by the at least one hotspot network, the wireless base station defers the transmission of the data packets until the wireless device enters the area covered by the at least one hotspot network.

In another embodiment of the present invention, a system may be configured to route content from at least one content provider to at least one consumer through a network using a wireless device. The system includes at least one content server, which is capable of participating in managing network resources. The system may also include a plurality of content routers and a plurality of access routers. In addition, the system may include a plurality of wireless base stations in communications with the plurality of access routers. At least one of the wireless consumers is associated with at least one of the plurality of wireless base stations when the wireless device of the at least one consumer is located in an area covered by the wireless base station. The base station aggregates at least one interest profile associated with the at least one consumer into a single interest profile, and stores content from the at least one content server based on which content descriptors associated with the content match with the single interest profile. The system may also include at least one wireless device in communication with the at least one of the plurality of wireless base stations, where the at least one wireless device receives content from the at least one wireless base station based on the at least one interest profile associated with the at least one consumer.

In yet another embodiment of the present invention, a system may be configured to route content from at least one content provider to at least one consumer through a network using a wireless device. The system includes at least one content server, which includes content having content descriptors associated with the content. The system may also include a plurality of wireless base stations in communications with the at least one content server. At least one of the wireless consumers is associated with at least one of the plurality of wireless base stations when the wireless device of the at least one consumer is located in an area covered by the wireless base station. The base station aggregates at least one interest profile associated with the at least one consumer into a single interest profile, and subscribes to content from the at least one content server based on the single interest profile. The system may also include at least one wireless device in communication with the at least one of the plurality of wireless base stations, where the at least one wireless device receives content from the at least one wireless base station based on the at least one interest profile associated with the at least one consumer.

In yet another embodiment of the present invention, a system may be configured to route content from at least one content provider to at least one content consumer through a network using a wireless device. In this system, the content is first routed through the IP network to at least one or more wireless base stations where it is cached based on content descriptors associated with the content. The system includes an IP network, at least one content server in communication with the IP network, where the content server includes a content delivery middleware, a content multicast socket, and a transport service interface. The system may also include a plurality of content routers in communication with the IP network. Each content router includes a content delivery middleware and a transport service interface. The system further includes at least one of a wired link or a wireless link and a plurality of access routers in communication with the IP network and at least one of the wired link or the wireless link. The access routers include a content delivery middleware and a transport interface. The system may also include at least one wireless base station in communication with the plurality of access routers, which may also include a content delivery middleware and a transport service interface. The system may also include at least one wireless device in communication with the at least one wireless base station, where the wireless device includes a content delivery middleware, a content multicast socket, and a transport service interface.

In accordance with other embodiments of the present invention, a computer readable medium for storing computer executable instructions for routing content through a network having at least one wireless base station based on its content from at least one content provider to at least one consumer is provided. The executable instructions may include receiving content from a content provider at a wireless base station, where the content has at least one content descriptor and the wireless base station has an information profile and stores the content that matches the information profile in a storage device. The executable instructions may also include generating data packets for transmission to the wireless device in response to receiving an interest profile and a cache directory associated with the wireless device, and transmitting the data packets from the wireless base station to the wireless device.

### BRIEF DESCRIPTION OF THE DRAWINGS

The present invention is now illustrated in connection with the accompanying drawings in which like references refer to like parts through and in which:

FIG. 1 illustrates an overview of a system for implementing some embodiments of the present invention.

FIG. 2 illustrates an overview of a semantic multicast network in accordance with some embodiments of the present invention.

FIG. 3 illustrates an illustrative example of a pro-active caching service in accordance with some embodiments of the present invention.

FIG. 4 illustrates an illustrative example of software architecture in the mobile devices and wireless base stations in accordance with some embodiments of the present invention.

FIG. 5 is a flow diagram showing one example of the controller controlling the macro timing of the wireless channel in accordance with some embodiments of the present invention.

FIG. 6 is a flow diagram showing one example of registering the mobile device in accordance with some embodiments of the present invention.

FIG. 7 is a flow diagram showing one example of determining whether the detected mobile device is associated with the wireless base station in accordance with some embodiments of the present invention.

FIG. 8 is a flow diagram showing one example of processing a message received from the mobile device in accordance with some embodiments of the present invention.

FIG. 9 is a flow diagram showing one example of processing another message received from the mobile device in accordance with some embodiments of the present invention.

FIG. 10 is a flow diagram showing one example of transmitting data packets to the mobile device in accordance with some embodiments of the present invention.

FIG. 11 is a flow diagram showing one example of scheduling content to be transferred to the mobile device in accordance with some embodiments of the present invention.

FIG. 12 is a flow diagram showing one example of receiving packet transmission status in accordance with some embodiments of the present invention.

FIG. 13 is a flow diagram showing one example of transmitting data packets to the mobile device in accordance with some embodiments of the present invention.

FIG. 14 is a flow diagram showing one example of managing content in accordance with some embodiments of the present invention.

FIG. 15 is a flow diagram showing one example of managing the cache when receiving data packets in accordance with some embodiments of the present invention.

### DETAILED DESCRIPTION

In the following detailed description, numerous specific details are set forth regarding the system and method of the present invention and the environment in which the system and method of the present invention may operate, etc., in order to provide a thorough understanding of the present invention. It will be apparent, however, to one skilled in the art that the present invention may be practice without such specific details. In other instances, well-known components, structures, and techniques have not been shown in detail to avoid unnecessarily obscuring the subject matter of the present invention. It is contemplated that there are other methods and systems that are within the scope of the present invention. Also, the same reference numerals are used in the drawings and in the description to refer to the same elements to simplify the description.

With the incorporation of a web browser into mobile devices, it is assumed that all value-added services are provided “via the web.” When a user selects the “My Music” link, a list of available songs is fetched from a web server. Then the user selects the songs s/he wants to hear, the songs themselves are downloaded to the device and immediately played (to the user). As the download is initiated in response to a direct user request, it needs to be fulfilled immediately and ideally at a bandwidth which allows the start of playback as soon as possible. To provide this service “anywhere, anytime,” a hybrid infrastructure of cellular and hotspot data networks has been proposed. As the cost difference between the two networks is very large, the cost of the cellular data will dominate the average price for most deployment scenarios.

But is that really the only, or even the best way to provide such a service? The Human-Computer Interface community has pointed out for a long time that mobile devices are used very differently from the way fixed devices are used. It is not only the different form factor, but more importantly, the context in which they are used. Applications for mobile devices are often referred to as “personal assistants”, “butlers”, or “valets” as they are designed to augment users' lives in a mainly peripheral role. For instance, in the context of a music service, a “Personal DJ” may be a more appropriate interface than a list of songs. A personal DJ can create a personalized entertainment program as it knows the individual's taste and preferences in music. Interaction with such an entity would take part at a more abstract level, such as “cheerful”, “somber”, “background”, or “keep me awake.”

The additional benefit of this approach is that the content needs to become predictable. Instead of having to respond to a specific user request immediately, content can be downloaded pro-actively at more opportune times. Or more specifically, downloads can be restricted to hotspots only.

In fact, this can have even wider implications. The cost of a hotspot is dominated by the cost of the backhaul link. As most hotspots are designed as simple bridges, the backhaul link should match the capacity of the wireless link for optimized performance. However, many deployment scenarios connect 50 Mbps access points with 1.5 Mbps DSL services—a significant mismatch. Backhaul capacity need not be the determinant cost factor for services whose content needs can be predicted in advance. If the access points are also equipped with local storage, pro-active non-real-time data caching will facilitate a break with the correlation between over-the-air, and backhaul needs. As a result, full advantage of the high wireless connection speed using cost effective backhaul technologies can be taken.

A system architecture and method for providing “near real-time” mobile multimedia services cost effectively has been provided. It achieves that by using pro-active caching at various points between the content provider and the content consumer (user). Caching decisions are driven by interest profiles describing the user's information needs. Caching in the mobile device allows users to consume the content without the simultaneous need for network connectivity. The cache is kept up-to-date whenever the user enters a hotspot (sometimes referred to herein as “I-Stations” or “base stations”) which provides high-speed connectivity at very low cost.

Usage of the wireless channel is enhanced by only needing to exchange data between a mobile and an I-Station. No additional overhead, such as assigning an IP address to a mobile and setting up a connection to a media server, or handing over an existing connection, is incurred. Additional pro-active caching in the I-Station minimizes bandwidth consumption on the backhaul link. In addition, the use of the backhaul link can be opportunistically scheduled to minimize interference with other, more delay-sensitive services provided by the I-Station.

The information profile of the I-Station, which determines the content it actively collects, is created from a prediction of the interest profiles of mobiles visiting in the future. The described exemplary embodiment uses an aggregation over the last N visiting mobiles with the assumption that user's interests change slowly over time and they also regularly visit the same places.

A content multicast network is used to distribute new content in an efficient and scalable manner from the content provider to all the relevant I-Stations.

In accordance with one embodiment of the present invention, systems and methods for routing content through a network having at least one wireless base station from at least one content provider to at least one content consumer are provided. Content from a content provider is received at a wireless base station, where the content has at least one content descriptor. The wireless base station has an information profile (sometimes referred to herein as an “interest profile”) and stores the content that matches the information profile in a storage device. In response to receiving an interest profile and a cache directory associated with a wireless device, data packets for transmission to the wireless device are generated based at least in part on the received interest profile and the received cache directory. The data packets are then transmitted from the wireless base station to the wireless device.

In accordance with other embodiments of the present invention, the system and method of the present invention provides mobile multimedia services over a wireless hotspot infrastructure. The system may include an “I-Station” wireless hot-spot base station and a mobile terminal. The system may use a content-based multicast network where publishers announce new content together with its metadata over the content-based multicast network, mobile terminals connect to the I-station hot-spot via a client application (user agent), and an I-Station connects to mobile terminals within hot-spot coverage and to the content-based multicast network via the “hotspot agent” application. The content-based multicast network distributes content from the content provider to all subscribing I-Stations based on matching the content metadata with the I-Stations' information profiles.

According to another embodiment of the invention, the system may be configured so that the I-Station connects to a Semantic Multicast Router (SMR) that routes data using content descriptors rather than IP addresses currently used for routing over the Internet.

In accordance with another embodiment of the invention, the system of the present invention may be configured to route content from at least one content provider through an IP network to at least one content consumer's wireless device. In this system, the content is first routed through the IP network to one or more I-Station units, where it is cached based on content descriptors associated with the content and where at least one of the content consumer or content provider is in communication with the network using a wireless device. The system includes an IP network, at least one content server in communication with the IP network, where the content server includes a content delivery middleware, a content multicast socket, and a transport service interface. The system may also include a plurality of content routers in communication with the IP network. Each content router includes a content delivery middleware, and a transport service interface. The system further includes at least one of a wired link or a wireless link and a plurality of access routers in communication with the IP network and at least one of a wired link or wireless link. The access routers include a content delivery middleware, and a transport service interface. The system may also include at least one I-Station unit in communication with the plurality of access routers (which again may include a content delivery middleware, and a transport service interface). The system may also include at least one wireless terminal in communication with the I-Station unit where the wireless terminal includes a content delivery middleware and a transport service interface.

According to another embodiment of the invention, the system and method of the present invention provides data to a “content consumer” using a mobile wireless terminal by means of data caching at various localized access points (hot-spots) whereby the caching decisions are driven by interest profiles describing end-user information needs.

According to yet another embodiment of the invention, the system and method may enable mobile terminal users connected to a hybrid wireless network, such as a wide-area low-bandwidth cellular coverage and local-area high-bandwidth hot-spot coverage. The users of the mobile terminals may defer data download until the mobile terminal comes within the hot-spot coverage area.

Under other embodiments of the invention, the method may also include one or more of the following: caching downloaded data in the mobile device allowing users to use the data without the simultaneous need for network connectivity; registering the mobile user with an I-Station whenever the mobile terminal enters the coverage of the I-Station; maintaining the interest profile of an application whenever the user enters the wireless coverage of an I-Station; usage of the wireless channel is enhanced by only needing to exchange data between the mobile terminal and an I-Station, with no additional overhead, such as assigning an IP address to a mobile and setting up a connection to a distant media server, or handing over an existing connection to an alternative bases, is incurred; performing pro-active caching of data that might be of interest to future visitors to the I-using the interest profiles of past visitors and visitors to surrounding I-Stations; opportunistically scheduling the I-station's cache data transfer over the back-haul channel to maintain the quality-of-service of other real-time traffic sharing the wireless hot-spot access point; synchronizing the data for download from the I-Station cache to the local cache of the Mobile terminal; and/or maintaining the local cache up-to-date as the mobile terminal enters and exists the coverage of I-Stations.

Under yet other embodiments of the invention, the present invention is a scalable system which can include a plurality of content-based routers distributed among the nodes of a semantic network overlay to an IP network where each of the plurality of content-based routers having a plurality of ports, the ports having, content servers, other content-based routers or I-Station units connected thereto.

Other embodiments of the present invention can also take the form of a computer readable medium for storing computer executable instructions for downloading and caching data from a content producer for subsequent delivery to a content consumer of a hot-spot wireless base station, where the content downloaded is based on the interest profiles of past and present users at the hot-spot. The executable instructions may include one or more of the following: receiving interest profiles from content consumers; predicting the interest profile of content consumers; subscribing to a content-based network based on the combined profile; storing content in a cache; and/or synchronizing cache content with visiting mobile terminals and completing partial downloads of data for mobile terminals holding only partial downloads of relevant content.

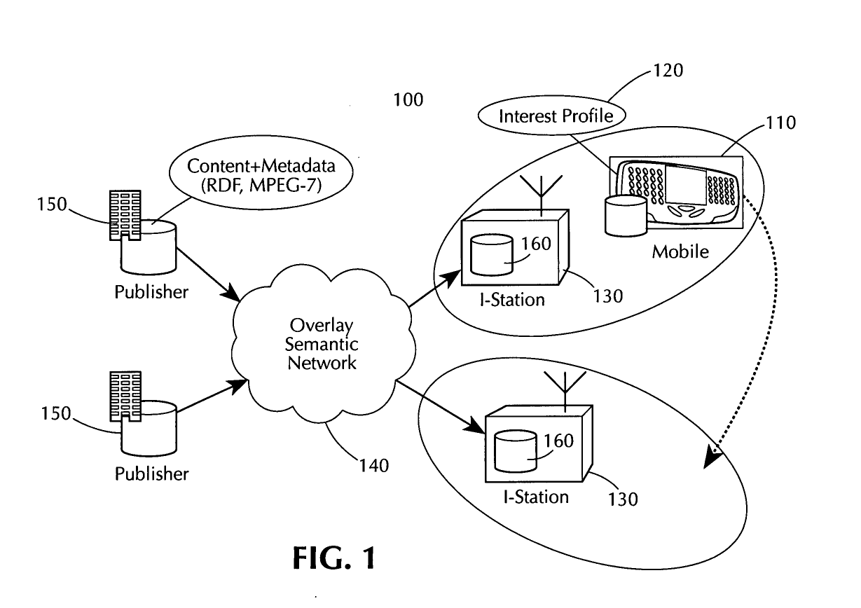

FIG. 1 illustrates one embodiment of a system 100, in which the present invention may be implemented. As illustrated in the system 100 shown in FIG. 1, applications on the mobile devices 110 describe their information or content needs through “interest profiles” 120 which they share with the hotspots 130 (sometimes referred to herein as “I-Stations” or “base stations”) they enter. The hotspots 130 themselves use these profiles 120 to predict the interest profile of the devices 110 visiting them. The hotspots 130 subscribe with this combined profile to a semantic multicast network 140 which will deliver new and relevant content to the I-Stations 130. The received content carries a content descriptor which matches the I-Station's information profile. This content, together with the associated meta-data, is stored in the I-Station's local storage (e.g., a cache, such as cache 160). While a mobile telephone is an exemplary embodiment of a mobile device 110 it should be understood that the term is meant to broadly to cover any mobile computing device including, but not limited to, laptops, PDAs, and dedicated media players with wireless capabilities.

When a mobile 110 visits an I-Station 130, the I-Station 130 retrieves the mobile's interest profile 120 and the content of its cache. The I-Station 130 then proceeds to download to the mobile 110 any content found in its own cache, which matches the mobile's interest profile 120, and is not already in the mobile's cache.

Content routing techniques represent an important new paradigm for delivering relevant information to mobile users in a timely manner. Unlike traditional multicast, the network 140 delivers information based on complex content profiles, thus assuring targeted delivery of relevant information. In this approach, I-Stations 130 subscribe to information and services via dynamically created “information profiles” which are used by the content-aware network 140 to route relevant data to each subscriber. In effect, the network 140 provides a highly granular form of “content multicasting” in which the network 140 delivers published content to mobiles 110 based on the user's information profiles 120, as well as, dynamic system attributes such as current location (location-aware), wireless link capacity, terminal capabilities, and quality-of-service (QoS).

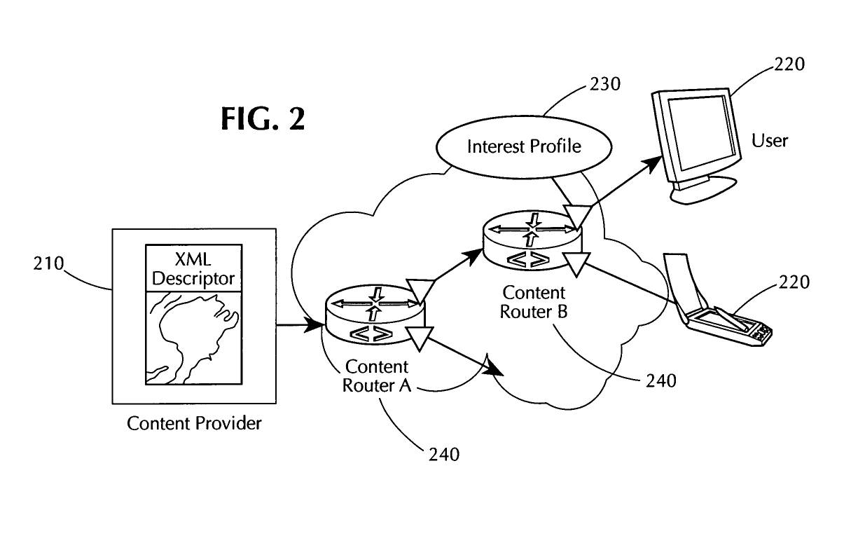

The content routers 240 (FIG. 2) in the access system propagate these profiles into the network 140 resulting in multicast of relevant music files to the mobile user from multiple content providers 150. Note that the user interest profile can be tailored to include cost and QoS constraints which determine the immediacy with which the data must be delivered and over what wireless medium.

In accordance with some embodiments of the present invention, this system may include one or more of the following components:

Content objects, such as text documents, music, images, video, and more.

Meta data describing each content object.

Profiles which describe a certain subset of content objects based on their meta data. A profile can also be viewed as a query on a meta data collection.

Users indicating their interest in a sub set of the available content objects through a profile.

Publishers publishing content objects and their associated meta data with the intend to have it distributed to all interested users. Content objects are published as information packets consisting of a content descriptor and optionally, the content as payload.

Agents which collect content objects in an associated content cache

Applications to present an agent's holding to a user

Packet network, such as an IP network to facilitate the exchange of content objects between specific agents

Content network, such as NetLink, which is a product available from Semandex Networks, Inc., the assignee of the present invention, to facilitate the distribution of content objects based on receiving agents' profile, as well as allowing an agent to efficiently query all other agents for content fitting a specific profile.

Mobile terminal attempts to provide a continuous service independent of network connectivity. It tries to predict the users information needs and maintains a local cache in which information is pro-actively loaded whenever it visits an I-Station. The information need is described through an “interest profile”. In addition, the capabilities of the terminal are described in a “capability profile” to ensure that only relevant content which can also be presented is downloaded.

I-Station provides a cost-effective communication link between the mobile clients and the fixed network. It contains a local cache in which it pro-actively stores information. In some embodiments, the I-Station may temporarily store relevant content for mobiles to mask the time a terminal is outside hotspot coverage. Alternatively, the cache in the mobile terminal may mask the time the terminal is outside hotspot coverage or any other suitable network coverage.

Download channel provides a shared high-speed communication link between an I-Station and all visiting mobile clients. This link is not assumed to be an extension of the larger network and is optimized for downloading information already available at the I-Station.

Each of these components is further described below.

Content providers publish content together with a content, or meta-data descriptor. This descriptor is encoded in XML and should use a standard schema appropriate for the type of content. The only restrictions are that publisher and consumer agree on the same set of standards.

Depending on “shelf-life” of content on one hand and the change rate of interest profiles on the other, it may be preferable to only publish content “announcements” without the actual content on the semantic network and have the subscribers fetch the actual content from the repositories via standard internet protocols directly.

A semantic multicast router (SMR) routes data based on content descriptors rather than IP (Internet Protocol) addresses currently used for routing over the Internet. The basic idea behind semantic routing is to provide a network infrastructure that directly links producers and consumers of information without having to go through the level of indirection associated with existing solutions such as search engines, directories, content lists, etc. The proposed approach is fundamentally more efficient and scalable than centralized methods in use today, and will enable timely delivery of relevant content in both fixed and mobile Internet scenarios.

FIG. 2 illustrates the semantic multicast network in accordance with some embodiments of the present invention. Documents are labeled with a content descriptor and simply sent into the network by the producer 210. On the other side, information consumers 220 express their interest to the network through an interest profile 230 and will then receive all published documents that match that interest. The network that connects the producer 210 and consumer 220 is content-aware and is capable of efficiently delivering information packets to subscribers based on their interest profiles. The basic building block of the network is the SMR (semantic multicast router) 240 that forwards data based on the match between content descriptors carried in the packet header and aggregated interest profiles corresponding to each router port.

The natural choice for content descriptors is the resource descriptor framework (RDF) standardized by the WWW Consortium (W3C). RDFs are based on XML schemas and the hundreds of specific schemas proposed and standardized by various standards bodies and industry groups.

Examples of the different types of agents are:

Repository agents whose holdings are maintained externally, for instance through a content management system, or an associated database. Repository agents are only participating in the distribution of content and are not collecting content objects from other agents.

User agents collect content objects on behalf of a user. Their profiles are determined by the user's interest. The profile may be managed directly by the user through an application, or may be inferred by a program from the user's action, or the context in which the information, application, or device is used.

Intermediary agents collect information in expectation of being contacted by other agents for relevant content. They function as intermediary between repository agents and user agents. Either these two types of agents cannot communicate directly, or the use of an intermediary agent will greatly enhance the efficiency of the overall system. Repository agents can collaborate with each other, or organize in a chain or hierarchy fashion to further increase their utility.

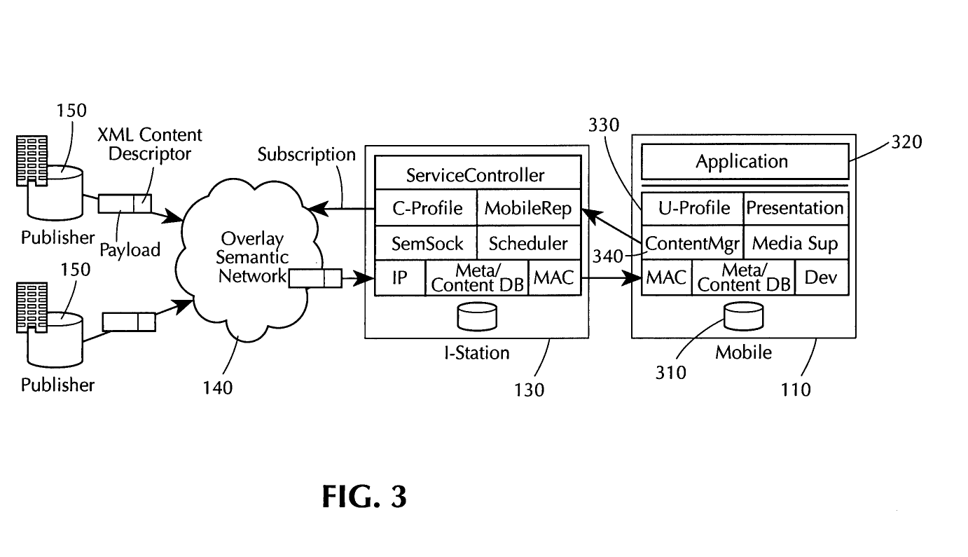

As shown in FIG. 3, the mobile terminal 110 provides a pro-active caching service 310 as a system component available to all content application. An application 320 will register its interest profile with the U-Profile manager 330. The ContentManager 340 will register with an I-Station 130 when it enters its coverage area (e.g., receives a corresponding beacon). In this embodiment, an authentication mechanism is not included as it is typically specified by the service provider. As part of the sign-on process, the mobile's interest profile as well as its current cache content is transferred to the I-Station 130. This information could be fetched from a device proxy on the fixed network or downloaded from the terminal as well. The former will consume backhaul bandwidth while the latter may require an extended upload consuming precious battery power. Our current implementation uses direct download.

The large size of many content packets requires fragmentation. It is possible that many content packets will not be downloaded in a single visit. As a result, a fragment counter is added to the cache descriptor which allows the next I-Station to resume download of a partial loaded packet.

As the information and data exchange is performed directly between the I-Station 130 and the mobile 110, there is no need for routing support. The link is operated as a link and it is not necessary to assign an IP address to the mobile 10 and therefore greatly reducing the sign-on time. Additional MAC layer based optimizations are possible. For instance, a strict upload scheme will reduce collisions and enhance throughput.

A hotspot is a wireless base station providing broadband connectivity within a limited range. They are normally deployed at high consumer traffic areas, such as airports, restaurants, toll booth, or traffic intersections. Hotspots normally operate as a network bridge, connecting a mobile device with a server or data provider inside the fixed network. In contrast, an I-Station is a hotspot that additionally includes a data cache which is pro-actively filled with information expected to be useful to the visiting mobile devices. In this scenario, data exchange is primarily between the mobile device and the I-Station.

As mentioned before, it is preferable not to operate the I-Station as an IP bridge as is common for hotspot access points. A bridge can only provide the capacity of the weakest link. In addition, the wireless link becomes an extension of the larger IP network, which requires the terminal to be assigned an IP address. This quickly leads to very complex and “signaling intensive” solutions, such as Mobile IP.

Instead, the wireless link is used to synchronize the I-Station's cache with that of the mobile terminal under the constraints of the mobile's interest profile. While this method optimizes network resources, it requires the I-Station to anticipate the interest profiles of its visiting terminals.

The I-Station stores the received information in a local cache. When a terminal enters an I-Station, the I-Station becomes aware of the terminal's profile and its current cache content. The I-Station compares the terminal's profile with the content descriptor of all the items in its—the hotspot's—cache and marks all the matches which are not already in the mobile's cache as download candidates. A download manager defines an appropriate download schedule for all the mobiles currently within communication range of the hotspots from their associated list of marked information items. QoS parameters can influence the scheduling priority, or delivery sequence to minimize the burden on the receiving terminal.

Two items in this design require further description. How does the I-Station build its profile and how is the mobile's profile and cache content transferred to the I-Station? As mentioned, a preferable profile for an I-Station is the aggregation of the profiles of all its future visitors. While attempts could be made to predict the likelihood of a mobile entering a particular hotspot from following its path in the past, most schemes proposed for this purpose require a large state space and sophisticated dynamic algorithms with questionable results. Predictions based on “crowd” behavior not only require less resources with often better results, but also match the preferred service concept better. For instance, the utility of caching an item depends on how often the same item can be served to different mobiles. In addition, interest affinity, lays at the heart of the scaling argument for semantic multicast. Or in other words, it is expected to find groups of users with similar interests in the same physical space.

The following illustrative embodiment is included to provide a better understanding of the system and method of the present invention.

Current cellular wireless networks are too expensive to provide a content distribution service to mobile devices. An alternative is to deploy short-range and high-speed “hotspots” in such a manner that most users will pass through their coverage within a reasonable time span. In addition, applications need to be designed which can predict a user's information need and pro-actively download this content when it passes through a hotspot.

One potential realization of such a system is a mobile device hosting an application mimicking a personal DJ, or personal radio. The application learns the user's preferences for music, collects songs fitting these preferences into local storage, creating a play list from the locally available songs, and finally, playing the songs in the order determined by the playlist.

In a conventional architecture, the mobile would establish a connection to a server in a data center through the hotspot's base station and initiate downloads of new content. This approach will incur a substantial start-up delay due to the connection setup with the server. It also requires backhaul capacity to match that of the hotspot. While the former may severely limit the hotspot's overall throughput, the latter may dominate the cost of providing such a service.

Such an exemplary system includes:

Publishers announce new content together with its metadata over the content network. They also store the content in their repository agents.

An intermediary agent is co-located with all hotspots.

Users carry a mobile device hosting a media application which provides the user with an “always-on” media feed, such as a personalized music feed.

A user agent may:
receive a user profile from the application;
contact a hotspot's agent whenever the mobile device enters the hotspot's coverage area; and
send this agent its profile.

The hotspot agent may:
search its local cache for content which fits the mobile agent's profile;
communicate with mobile agent to determine its cache content; and
download relevant content not already stored on mobile.

The hotspot agent may also:
create a profile predicting the profiles of future visiting mobiles; and
subscribe to a content network to maintain its local cache based on its predicted profile.

This described architecture has the following exemplary advantages:

The mobile only communicates with the agent on the hotspot, therefore, reducing startup delays.

The backhaul is only used for maintaining the hotspot's cache and does not need to be matched to the wireless channel's bandwidth.

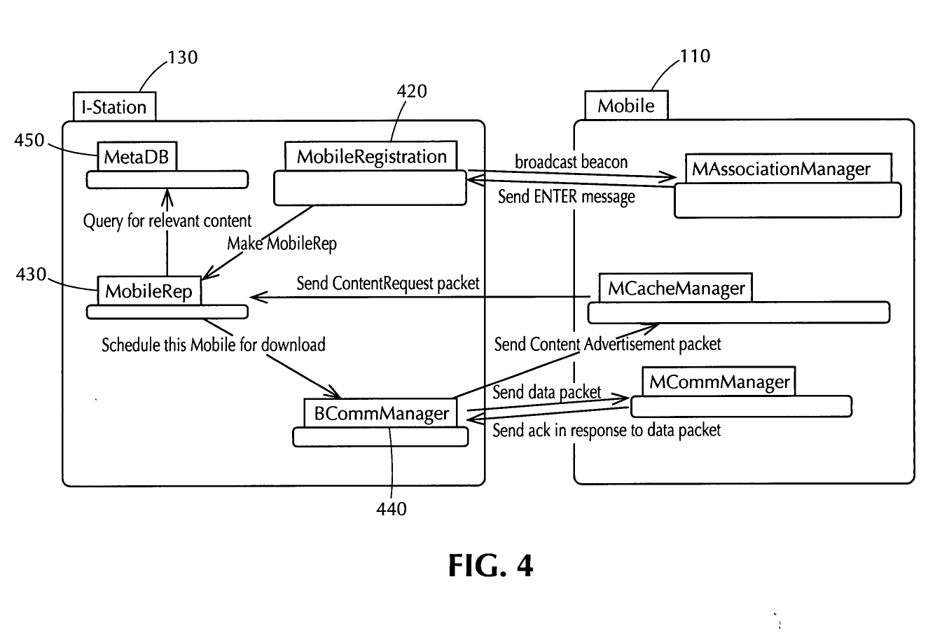

The software architecture of the system of the present invention, as shown in FIG. 4, includes the following components.

Controller: This component controls the macro timing of the wireless channel. During the contention period it activates the MobileRegistration 420 component, while during the download period it activates the BCommManager 440.

MobileRegistration 420: This component discovers the arrival and departure of mobiles. It broadcasts a beacon at the beginning of the contention period and will then listen for messages from mobiles during the remaining period. For any newly discovered mobile a MobileRep 430 object is created.

MobileRep (MR) 430: Every visiting mobile is represented by an instance of this type during the time it is associated with that base station. The initial “ENTER” message from the mobile contains the mobile's interest profile (MIP). The MR 430 then queries the MetaDB 450 with the MIP to obtain a list of locally stored content which is relevant to the mobile. It will then correspond with the mobile (through the BCommManager 440) to remove all items from this list which are already stored on the mobile. Finally, it will coordinate the download of the remaining items on the list with the BCommManager 440.

BCommManager 440: This component is activated during the contention-free time slot and schedules, and facilitates downloads from all “pending” MobileReps 430 to their respective mobiles.

MetaDB 450: This component stores the metadata of all the content stored in ContentCache. The current implementation uses XPath formatted queries.

ContentCache: This component stores all locally available content.

Controller

The Controller activates MobileRegistration 420 and BCommManager 440 in a round-robin fashion for a fixed but configurable amount of time in milliseconds.

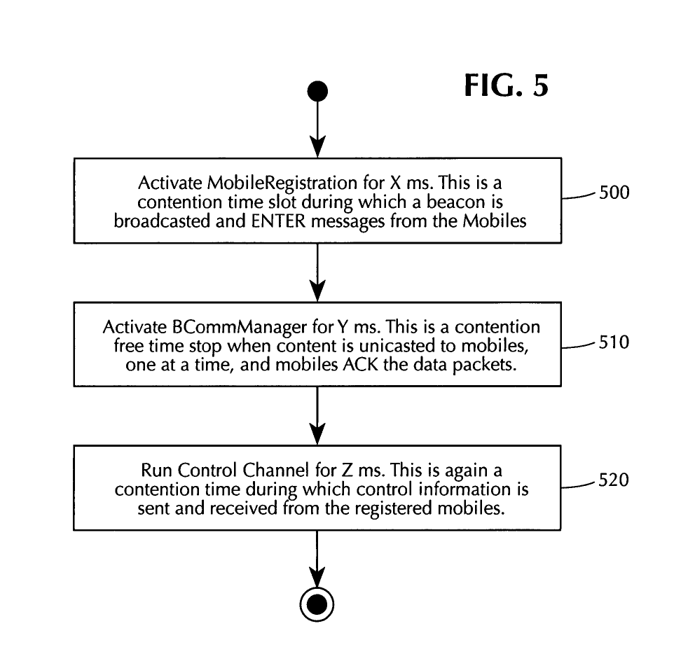

FIG. 5 illustrates an exemplary embodiment of one iteration of a loop the Controller performs repeatedly while the I-Station 130 is active. It may enforce a periodic usage pattern of the wireless channel. Each period preferably consists of a contention slot, followed by a contention-free slot. Specifically, the Controller activates the MobileRegistration 420 component for X ms (the contention period) (step 500), and the BCommManager 440 for Y ms (the contention free period) (step 510). It should be noted that the values X and Y are configurable.

MobileRegistration

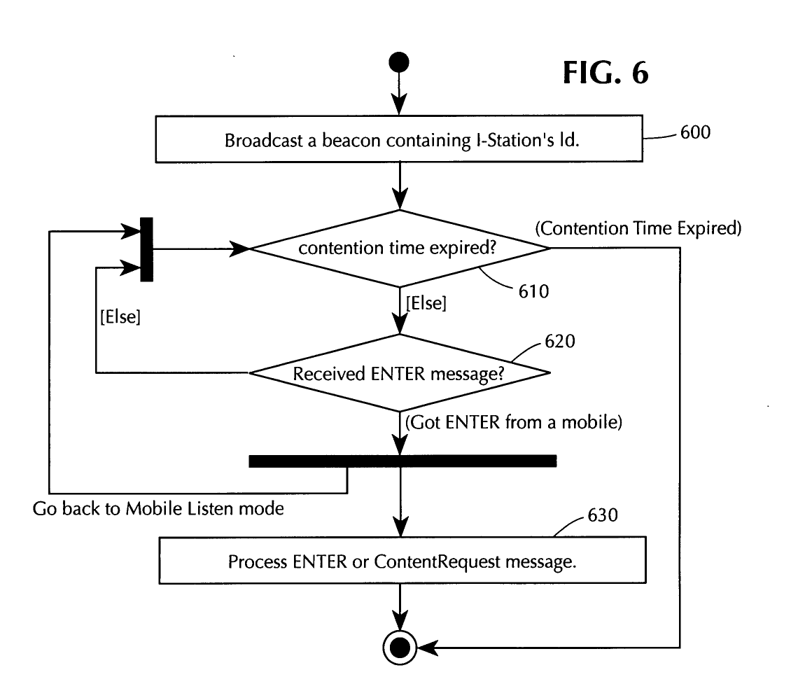

FIG. 6 illustrates an exemplary flow diagram of the MobileRegistration (MR) 420 while it is activated. It first sends out a beacon (step 600). The beacon contains the I-Station's ID. The beacon is an invitation to newly arrived mobiles to advertise their presence to the I-Station. After the MR has sent the beacon it will listen for messages (step 620) until it becomes de-activated by the Controller (step 610).

MAssociationManager

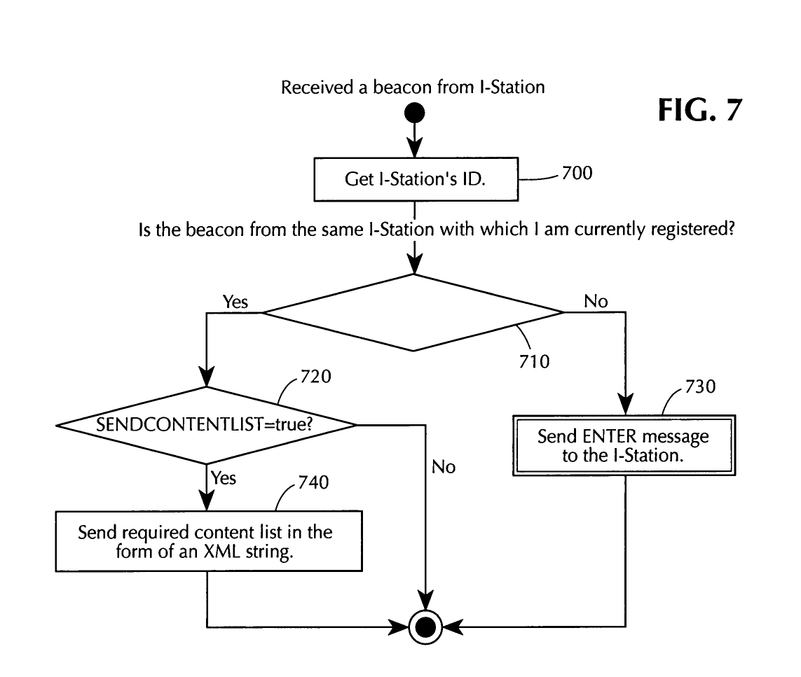

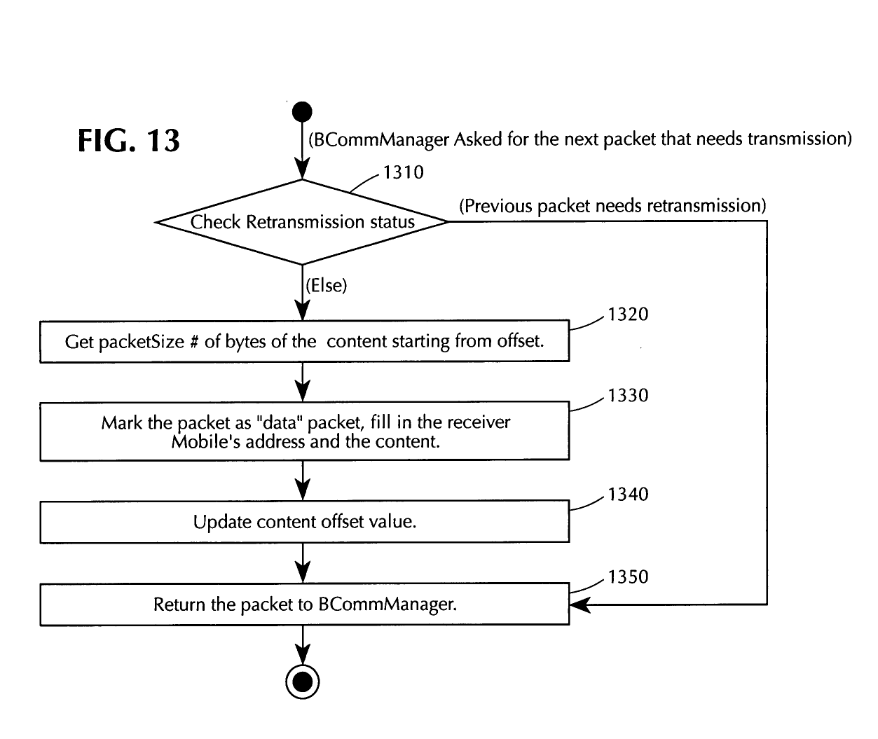

When an MAssociationManager receives a beacon, as shown in FIG. 7, it extracts the I-Station ID (step 700) and checks if it is from the I-Station it is already fully associated with (step 710). If it is and the “SendContentList” flag (step 720) is false, processing stops. Otherwise, it sends a “ContentRequest” message back to the I-Station (step 740). The content of this message and how it is created is later described in FIG. 13. It should be noted that the I-Station may acknowledge the receipt of this message with an “ACK” which, when received by the mobile will clear the “SendContentList” flag.

If this mobile is not yet associated with any I-Station, or the received signal from this I-Station indicates a better communication link (step 71), it will send an “Enter” message (step 730) which also includes the mobile's interest profile.

Mobile Registration—Processing Messages

Returning to the MobileRegistration component and how it processes the different messages it can receive from a mobile.

Processing “ENTER” message

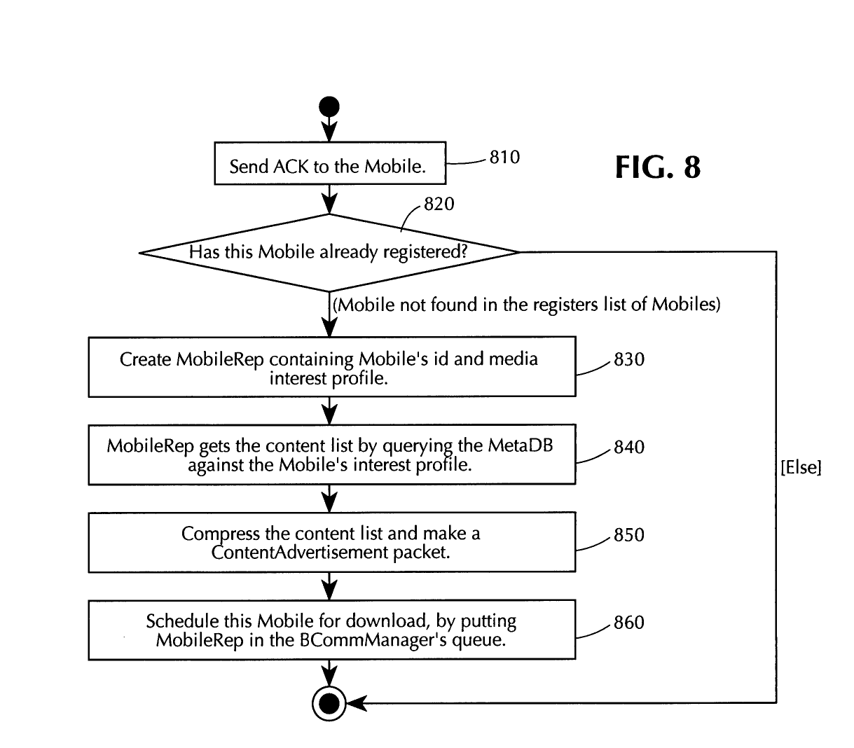

After receiving an “Enter” message, as shown in FIG. 8, an “ACK” message is immediately sent back to the mobile (step 810). If the mobile is already registered, nothing further needs to be done (step 820). This path is taken if all previous “ACK” messages have not been received by the mobile and the mobile is attempting to register again.

If this is the first “ENTER” message received from a particular mobile, the MobileRegistration creates a MobileRep (MR) object to coordinate further communication with this mobile (step 830). The “ENTER” message contains additional information which is consequently processed by the newly created MR instance (steps 840, 850, and 860).

The “ENTER” message contains the mobile's interest profile. The MR turns the interest profile into a query to the MetaDB which returns a list of all media objects in the local ContentCache whose meta data match the mobile's interest profile (step 840). The MR now needs to determine which items on this list are not already in the mobile's cache. It achieves that by creating (step 850) and sending (step 860) potentially multiple “ContentAdvertisements” messages containing a maximum number of items from the above list to the mobile. In this exemplary embodiment, the MR does not directly send to the mobile, but instead enters itself into the BCommManager's pending list. The BCommManager will request the message when it schedules a download to the associated mobile.

Processing “ContentRequest” Message

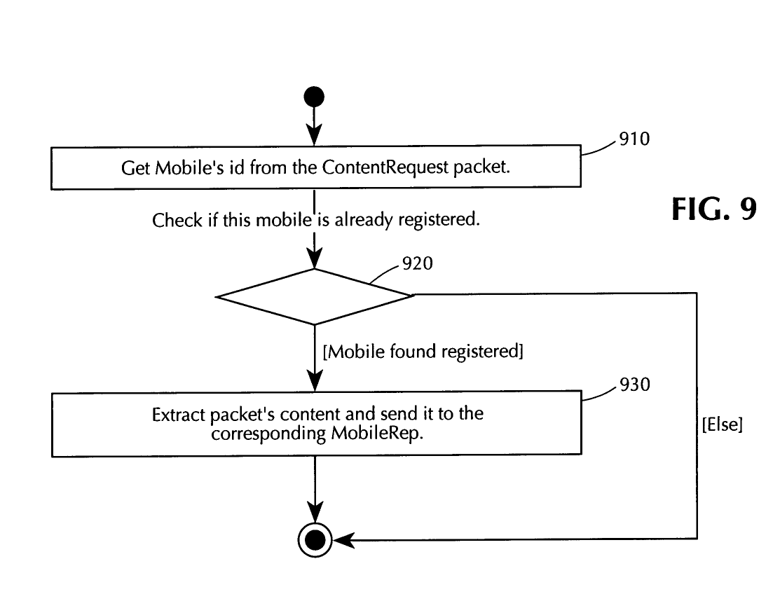

As shown in FIG. 9, if the received message is a “ContentRequest” message, the message is forwarded to the MobileRep object assigned to the mobile which sent this message (step 930). If this mobile is not registered with this I-Station the message (step 920), the message is quietly dropped.

BCommManager

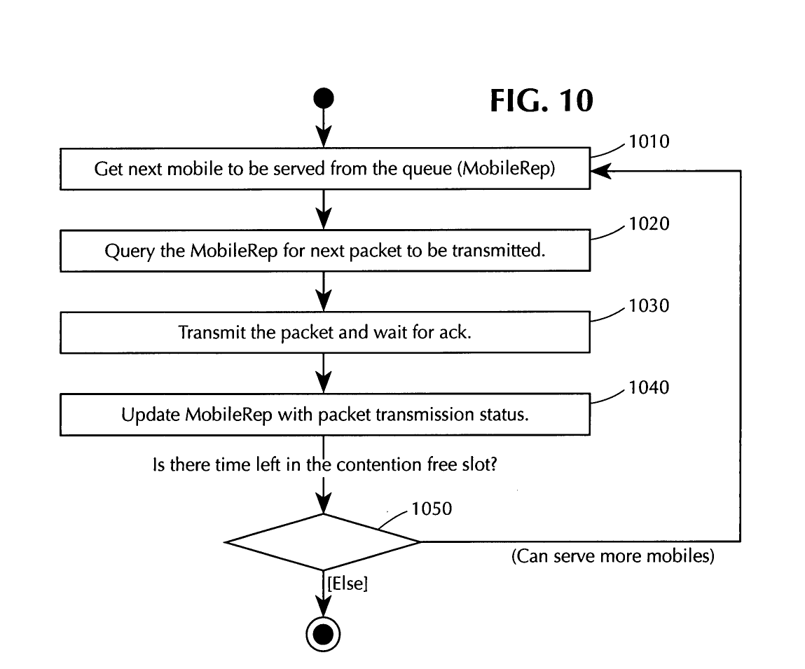

The BCommManager (BCM) maintains a list of MobileReps (MR) which have packets pending to be sent to their respective mobiles. As shown in FIG. 10, the BCM picks a MR from the queue (step 1010), and queries it for the next packet to be transmitted (step 1020). The returned packet can for example be a data packet or a ContentAdvertisement packet.

The BCM transmits the packet and waits for an ACK from the mobile (step 1030) to indicate successful reception. If an ACK is not received within a certain time-out period (in ms), the BCM considers the packet to be lost. The MR is informed of the packet's transmission status (step 1040). In the current implementation, the BCM continues to send packets to mobiles until the end of the contention-free period, or if there are no more pending MRs in its queue (step 1050).

In the exemplary embodiment, the queue is served in a FIFO fashion. The BCM removes the first MR from the queue and requests the next package to send from the same. If this MR has more data to send, it needs to add itself to the queue again.

In some embodiments, a more advanced scheduling algorithm may be implemented that prioritizes communication considering the “goodness” or quality of the channel between the I-Station and the mobiles. The quality of the channel can be measured by observing parameters such as, the error rate, the received power of packets from a mobile, or the negotiated bandwidth.

MobileRep

The MobileRep is a representation of the Mobile at the I-Station. It is responsible for:

Creating a list of locally available content by querying MetaDB with the mobiles interest profile.

Offering the items on this list to the mobile by sending “ContentAdvertising” packets.

Culling the list by processing the mobile's “ContentRequest” packets.

Fetching content from the ContentCache.

Creating data packets for download by the BCommManager.

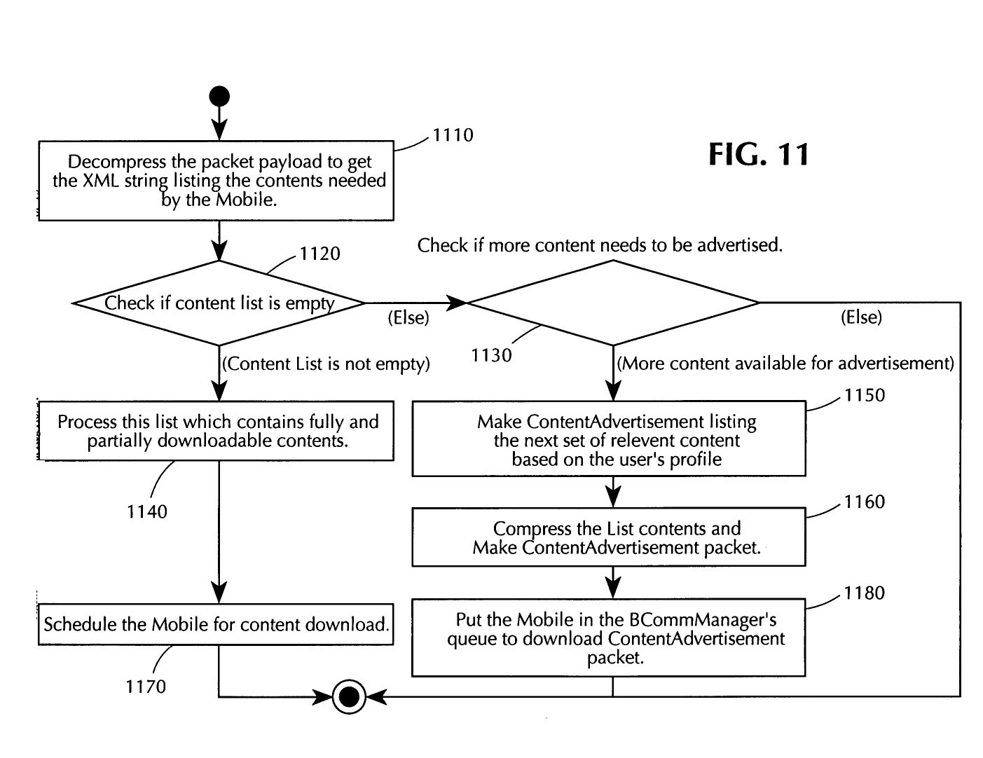

FIG. 11 is a flowchart of illustrative steps that a MobileRep takes to process a “ContentRequest” message sent by a mobile in response to a “ContentAdvertisement “packet.

A Mobile sends the list of content-ids, which it is interested in receiving. The list, encoded in XML, can be in a compressed form and, if it is, it has to be de-compressed first (step 1110). If the list is empty (step 1120), a check is performed to determine if there is additional content which can be advertised to the Mobile (step 1130). If more content is found, a new ContentAdvertisement packet is created (step 1150), its content compressed (step 1160), and the MobileRep adds itself to the BCommManager's pending queue (step 1180).

If no additional content can be offered to the mobile, it is assumed that all locally available content which is of interest to the mobile has already been downloaded into the mobile's cache. In this case no further interaction with this mobile is necessary.

If the “ContentRequest” message does contain content-ids (step 1120), the list is processed (step 1140), and the MobileRep adds itself to the BCommManager's pending queue (step 1170) to initiate downloading of the requested media objects.

Packet Transmission Status

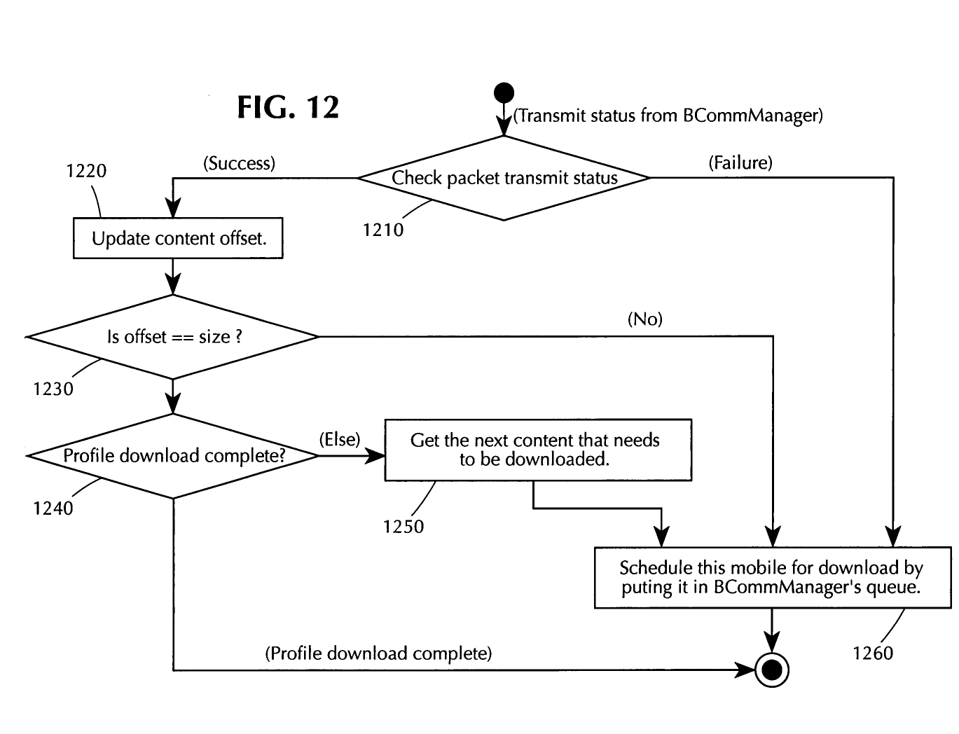

The MobileRep also processes the packet transmission status provided by the BCommManager (step 1210) as shown in FIG. 12. If the download of the last packet provided by the MobileRep failed (step 1210), the MobileRep will re-submit itself to the BCommManager's pending queue.

If the transmission succeeded (step 1210), the respective internal state is updated (step 1220). A media object can be of arbitrary size, but the size of a packet being sent to a mobile is preferably capped at a certain size. Therefore, the download of a particular media object may span across multiple packets. In this case a packet is characterized by an offset into the underlying media object determining the start of the packet's content.

If the last successfully downloaded packet does not forward the offset into the media object to its end (step 1230), an additional packet is scheduled for download (step 1260).

If a media object is completely downloaded, the list of outstanding media object is checked (step 1240). If the list is empty, no further downloads are needed and the MobileRep can retire. If the list is non-empty, the next media object is fetched from the ContentCache (step 1250), and the MobileRep will add itself to the BCommManager's pending queue (step 1260).

BCommManager Callback

FIG. 13 illustrates the steps that MobileRep walks through when the BCommManager calls back for the next data packet to be transmitted. The MobileRep checks to see if the previous packet transmission failed (step 1310), in which case it re-submits the previous packet to the scheduler for transmission. Else, it gets the next set of bytes to be transmitted (step 1320), configures the packet with identification information (step 1330) and returns it to the scheduler (step 1350).

MCacheManager

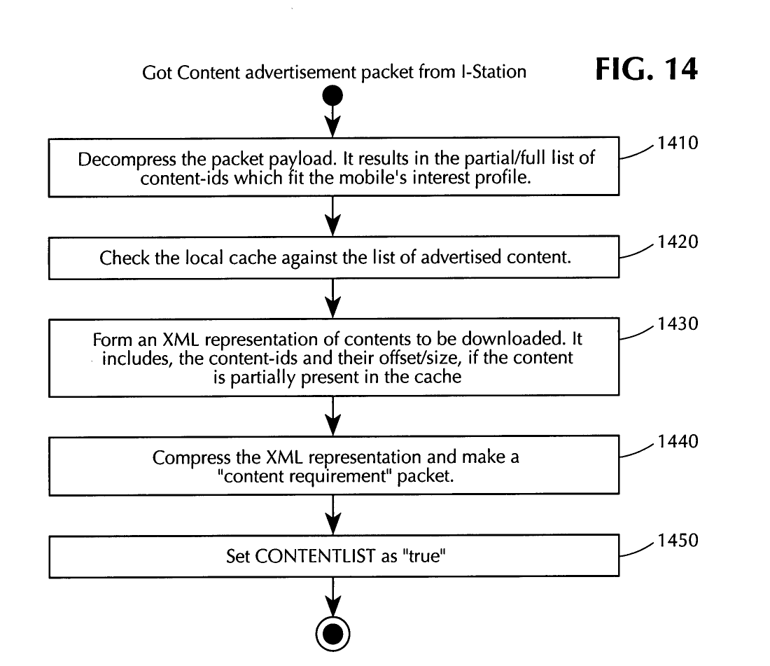

The MCacheManager responds, as shown in FIG. 14, to “ContentAdvertisement” packets by checking the advertised content against its locally available content (step 1420). Any content which is not found or is partially downloaded is then requested from the I-Station. The MCacheManager creates an XML representation of the content-ids which are fully or partially required to be downloaded (step 1430).

After creating a “ContentList” packet, the SENDCONTENTLIST flag in the MAssociationManager (AM) is set to true (step 1440). The next time the AM receives a beacon it will request this packet and return it to the I-Station.

MCommManager

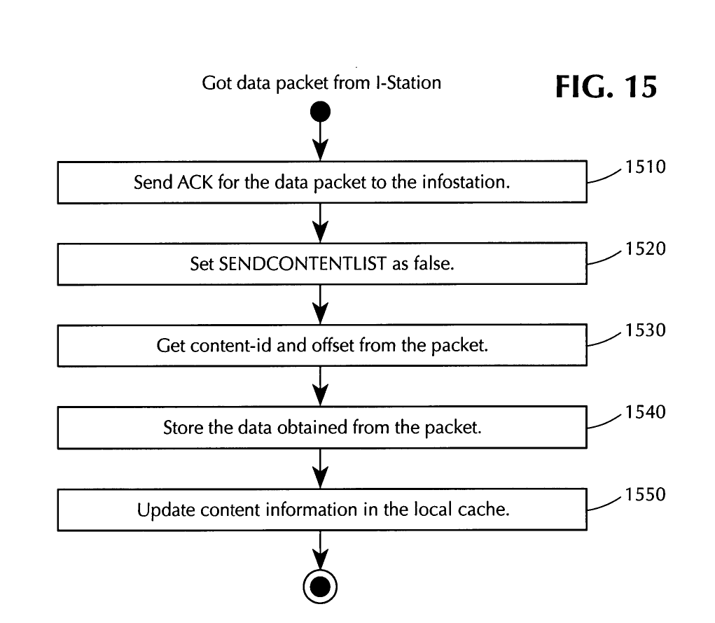

FIG. 15 explains the sequence of steps taken by the MCommManager when it receives a data packet.

It acknowledges every data packet, even if it is a duplicate packet (step 1510). Further, it unsets the SENDCONTENTLIST flag in the MAssociationManager (step 1520), to make sure that no further “ContentRequest” packet are sent in reply to beacons. Further, content and download details are extracted from the data packet (step 1530), the content is stored (step 1540) and local cache is updated to reflect the current content status (step 1550).

### ALTERNATIVE EMBODIMENTS

In the implementation described above, the I-Station is a subscriber to the content network and therefore is connected to a content router, such as the Toha, which is a product available from Semandex Networks, Inc., the assignee of the present application, on the side of the fixed network.

If it is desirable to control the traffic over the backhaul link even more closely, the Toha (content router) would be configured as the default IP router for the I-Station. In this case, all traffic to the I-Station would pass through the Toha. Some of the I-Stations functionality, specifically SemSock plus a thin profile management component, would be moved to the Toha. The IP router on the Toha would prioritize traffic to the I-Station. Specifically, delay-sensitive data, such as web content, or VOIP, would get precedence over content received over the content network to update the I-Station's content cache.

It should also be noted that the content network can be provided on top of IP multicast by mapping meta-data on to IP multicast addresses.

Although the present invention has been described and illustrated in the foregoing exemplary embodiment, it is understood that the present disclosure has been made only by way of example, and that numerous changes in the details of construction and combination and arrangement of processes and equipment may be made without departing from the spirit and scope of the disclosed invention, which is limited only by the claims which follow.

1. A method for routing content through a network having at least one wireless base station from at least one content provider to at least one wireless device, the method comprising:
receiving content from a content provider at a wireless base station, wherein the content has at least one content descriptor and wherein the wireless base station includes an information profile and stores the content that matches the information profile in a storage device;
receiving an interest profile and a cache directory associated with a wireless device;
generating data packets for transmission to the wireless device based at least in part on the received interest profile and the received cache directory, wherein the data packets are generated from the stored content; and
transmitting the data packets from the wireless base station to the wireless device.

2. The method of claim 1, wherein the step of transmitting the data packets to the wireless device using the wireless base station, further comprises:
transmitting a first portion of the data packets to the wireless device using a first wireless base station;
disconnecting from the first wireless base station while connecting to a second wireless base station; and
transmitting a second portion of the data packets to the wireless device using the second wireless base station.

3. The method of claim 2, wherein the first wireless base station communicates with the second wireless base station to inform the second wireless base station of the size of the first portion of the data packets transmitted to the wireless device.

4. The method of claim 2, wherein the first wireless base station transmits the received interest profile and the received cache directory associated with the wireless device to the second wireless base station.

5. The method of claim 2, wherein the first wireless base station transmits a leading portion of the second portion of the data packets until the wireless device connects to the second wireless base station.

6. The method of claim 5, wherein the second wireless base station transmits a remaining portion of the second portion when the wireless device connects to the second wireless base station.

7. The method of claim 1, further comprising subscribing to the content provider for content based on the information profile.

8. The method of claim 1, further comprising downloading content from content providers based on the information profile.

9. The method of claim 1, further comprising downloading content from a content network.

10. The method of claim 1, further comprising updating the information profile based at least in part on the received interest profile.

11. The method of claim 1, further comprising updating the information profile based at least in part on information profiles associated with other wireless base stations and interest profiles received at the other wireless base stations.

12. The method of claim 1, further comprising predicting the interest profiles of content consumers based at least in part on information profiles associated with other wireless base stations and interest profiles received at the other wireless base stations.

13. The method of claim 1, wherein the wireless base station does not assign an IP address to the wireless device.

14. The method of claim 1, wherein the wireless base station allows the content consumer to connect to a hybrid wireless network, wherein the hybrid wireless network includes at least a cellular data network and a hotspot data network.

15. The method of claim 14, further comprising providing the content consumer with an opportunity to select to receive content only from the hotspot data network of the hybrid wireless network.

16. The method of claim 14, further comprising -providing the content consumer with an opportunity to select to receive content only from the cellular data network of the hybrid wireless network.

17. The method of claim 14, further comprising deferring transmitting the data packets until the wireless device enters an area that the hotspot data network covers.

18. The method of claim 14, further comprising deferring transmitting the data packets until the wireless device enters an area covered by a network selected by the content consumer that is within the hybrid wireless network.

19. The method of claim 1, further comprising:
synchronizing the stored content with the wireless device based at least in part on the received cache directory; and
completing partial transmissions of data packets when the received cache directory associated with the wireless device indicates a partial transmission of the stored content.

20. The method of claim 1, wherein the interest profile and the information profile are expressed in the XML programming language.

21. The method of claim 1, wherein the at least one content descriptor is expressed in the XML programming language.

22. The method of claim 1, wherein the interest profile and the cache directory associated with the wireless device are received from the wireless device.

23. The method of claim 1, wherein the interest profile and the cache directory associated with the wireless device are received from another wireless base station.

24. The method of claim 1, wherein the interest profile and the cache directory associated with the wireless device are received from a server connected to the network.

25. A method for routing content through a network having at least one wireless base station from at least one content provider to at least one consumer, the method comprising:
using a wireless base station to connect to a hybrid network comprising at least one hotspot data network and at least one cellular network;
receiving content that is transmitted from at least one content provider to a wireless base station through the hybrid network, wherein the content has at least one content descriptor and the wireless base station has an information profile;
storing at least a portion of the transmitted content at the wireless base station based on whether the at least one content descriptor matches the information profile;
receiving an interest profile and a cache directory associated with a wireless device;
generating data packets of the stored content for transmission to the wireless device based at least in part on the received interest profile and the received cache directory;
receiving an indication from the user of the wireless device to transmit the stored content to the wireless device when the wireless device is in an area covered by the at least one hotspot network; and
deferring the transmission of the data packets until the wireless device enters the area covered by the at least one hotspot network.

26. A system for routing content from at least one content provider to at least one consumer through a network using a wireless device, the system comprising:
at least one content server, wherein the at least one content server is capable of participating in managing network resources;
a plurality of content routers;
a plurality of access routers;
a plurality of wireless base stations in communications with the plurality of access routers, wherein:
at least one consumer is associated with at least one of the plurality of wireless base stations when the wireless device of the at least one consumer is located in an area covered by the at least one of the plurality of wireless base stations;
the at least one of the plurality of wireless base stations aggregates at least one interest profile associated with the at least one consumer into a single interest profile; and
the at least one of the plurality of wireless base stations stores content from the at least one content server based on which content descriptors associated with the content match with the single interest profile; and
at least one wireless device in communication with the at least one of the plurality of wireless base stations, wherein the at least one wireless device receives content from the at least one wireless base station based on the at least one interest profile associated with the at least one consumer.

27. A system for routing content from at least one content provider to at least one consumer through a network using a wireless device, the system comprising:
at least one content server, wherein the at least one content server comprises content having content descriptors associated with the content;
a plurality of wireless base stations in communications with the at least one content server, wherein:
at least one consumer is associated with at least one of the plurality of wireless base stations when the wireless device of the at least one consumer is located in an area covered by the at least one of the plurality of wireless base stations;
the at least one of the plurality of wireless base stations aggregates at least one interest profile associated with the at least one consumer into a single interest profile; and
the at least one of the plurality of wireless base stations subscribes to content from the at least one content server based on the single interest profile; and
at least one wireless device in communication with the at least one of the plurality of wireless base station, wherein the at least one wireless device receives content from the at least one wireless base station based on the at least one interest profile associated with the at least one consumer.

28. A system for routing content from at least one content provider through a network to at least one consumer's wireless device, wherein the content is routed through one or more wireless base stations based on content descriptors associated with the content, the system comprising:
an IP network;
at least one content server in communication with the IP network, wherein the at least one content server comprises:
a content delivery middleware;
a content multicast socket; and
a transport service interface;
a plurality of content routers in communication with the IP network, wherein each of the plurality of content routers comprises:
a content delivery middleware; and
a transport service interface;
at least one of a wired link or a wireless link;
a plurality of access routers in communications with the IP network and at least one of a wired link or a wireless link, the plurality of access routers comprising:
a content delivery middleware; and
a transport service interface;
at least one wireless base station in communication with the plurality of access routers, the at least one wireless base station comprising:
a content delivery middleware; and
a transport service interface; and
at least one wireless device in communication with the at least one wireless base station, the wireless device comprising:
a content delivery middleware;
a content multicast socket; and
a transport service interface.

29. A computer readable medium for storing computer executable instructions for routing content through a network having at least one wireless base station based on its content from at least one content provider to at least one consumer, the executable instructions comprising the steps of:
receiving content from a content provider at a wireless base station, wherein the content has at least one content descriptor and wherein the wireless base station has an information profile and stores the content that matches the information profile in a storage device;
receiving an interest profile and a cache directory associated with a wireless device;
generating data packets for transmission to the wireless device based at least in part on the received interest profile and the received cache directory, wherein the data packets are generated from the stored content; and
transmitting the data packets from the wireless base station to the wireless device.
